(19) United States
(12) Patent Application Publication
(10) Pub. No.: US 2026/0202280 A1
(43) Pub. Date: Jul. 16, 2026

(54) METHODS FOR ANALYZING HOLLOW CORE OPTICAL FIBERS

(71) Applicant: CORNING INCORPORATED, CORNING, NY (US)

(72) Inventor: Riley Saunders Freeland, Corning, NY (US)

(21) Appl. No.: 19/441,197

(22) Filed: Jan. 6, 2026

Related U.S. Application Data
(60) Provisional application No. 63/744,966, filed on Jan. 14, 2025.

(51) Int. Cl. G01M 11/00

(52) U.S. Cl. CPC G01M 11/30

(57) ABSTRACT

A method for analyzing a hollow core optical fiber includes: disposing a photodetector at an angle greater than 0° and less than 180° relative to a longitudinal axis of a hollow core optical fiber; injecting light into the hollow core optical fiber; measuring, via the photodetector, optical power of the light transmitted through a side of the hollow core optical fiber; and detecting a defect in the hollow core optical fiber based on the measured optical power.

This application claims the benefit of priority to U.S. Provisional Patent Application Ser. No. 63/744,966 filed on Jan. 14, 2025, the content of which is relied upon and incorporated herein by reference in its entirety.

### FIELD

The present specification generally relates to hollow core optical fibers and, more specifically, to methods for analyzing hollow core optical fibers.

### TECHNICAL BACKGROUND

Hollow core optical fibers transmit light through a hollow core. Performance of the hollow core optical fiber is generally characterized by the optical power transmitted through the fiber. Different factors, such as deformations that occur during manufacturing, may affect the overall performance of the hollow core optical fiber. For example, maintaining the desired architecture when drawing a preform into hollow core optical fiber may be challenging because the capillaries may detach from a substrate wall, touch an adjacent capillary, and deform from the desired shape unintentionally during the drawing process. These defects may be local (i.e., short in length), or distributed along the length of the fiber. Some defects may also appear as length-dependent non-uniformity of the geometry of the fiber. The presence of a defect may be determined via scattering analysis. However, conventional methods of evaluating scattering may not be suitable for evaluating the presence of a defect in a hollow core optical fiber or determining the defect itself.

Accordingly, there is a need for alternative methods for analyzing a hollow core fiber which allow for determination of not only the presence of a defect therein, but determination of the defect itself.

### SUMMARY

According to a first aspect A1, a method for analyzing a hollow core optical fiber comprises: disposing a photodetector at an angle greater than 0° and less than 180° relative to a longitudinal axis of a hollow core optical fiber; injecting light into the hollow core optical fiber; measuring, via the photodetector, optical power of the light transmitted through a side of the hollow core optical fiber; and detecting a defect in the hollow core optical fiber based on the measured optical power.

A second aspect A2 includes the method of the first aspect A1, wherein the measuring of the optical power comprises evaluating a longitudinal angular distribution of the optical power of the light transmitted through a side of the hollow core optical fiber.

A third aspect A3 includes the method of the second aspect A2, wherein the detecting is based on the longitudinal angular distribution.

A fourth aspect A4 includes the method of any one of the first through third aspects A1-A3, wherein the detecting comprises determining a location of the defect.

A fifth aspect A5 includes the method of the fourth aspect A4, wherein the method further comprises removing a portion of the hollow core optical fiber, the portion including the defect.

A sixth aspect A6 includes the method of any one of the first through fifth aspects A1-A5, wherein the detection comprises identifying the defect.

A seventh aspect A7 includes the method of any one of the first through sixth aspects A1-A6, wherein the photodetector comprises a plurality of photodetectors disposed at various angles greater than 0° and less than 180° relative to the longitudinal axis of the hollow core optical fiber.

An eighth aspect A8 includes the method of any one of the first through seventh aspects A1-A7, wherein the light is injected into a core of the hollow core optical fiber, a substrate of the hollow core optical fiber, a capillary of the hollow core optical fiber, or combinations thereof.

A ninth aspect A9 includes the method of any one of the first through eighth aspects A1-A8, wherein the light injected into the hollow core optical fiber comprises a wavelength greater than or equal to 1000 nm and less than or equal to 1700 nm.

A tenth aspect A10 includes the method of any one of the first through ninth aspects A1-A9, wherein the light injected into the hollow core optical fiber comprises a plurality of wavelengths.

An eleventh aspect A11 includes the method of any one of the first through tenth aspects A1-A10, wherein during the measuring step, the hollow core optical fiber is moved along the longitudinal axis of the hollow core optical fiber.

A twelfth aspect A12 includes the method of any one of the first through eleventh aspects A1-A11, wherein during the measuring step, the photodetector is moved along an arc at angles greater than 0° and less than 180° relative to the longitudinal axis of the hollow core optical fiber.

A thirteenth aspect A13 includes the method of any one of the first through twelfth aspects A1-A12, wherein the defect of the hollow core optical fiber comprises capillary detachment, capillaries touching, capillary deformities, capillary gap deformities, or a combination thereof.

A fourteenth aspect A14 includes the method of any one of the first through thirteenth aspects A1-A13, wherein the detecting the defect comprises comparing the measured optical power to a predetermined threshold.

A fifteenth aspect A15 includes the method of any one of the first through fourteenth aspects A1-A14, wherein the method further comprises stripping a polymer coating from the hollow core optical fiber prior to the measuring step.

Additional features and advantages of the methods of analyzing a hollow core optical fiber will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 is an image of side scattering from a lossy hollow core optical fiber;

FIG. 2 schematically depicts a cross-sectional view of a hollow core preform, according to one or more embodiments described herein;

FIG. 3 schematically depicts a draw production system, according to one or more embodiments described herein;

FIG. 4 schematically depicts a cross-sectional view of a hollow core optical fiber drawn from a hollow core preform, according to one or more embodiments described herein;

FIG. 5 is a flow chart of a method for analyzing a defect of a hollow core optical fiber, according to one or more embodiments described herein;

FIG. 6 schematically depicts steps of the method for analyzing a defect of a hollow core optical fiber, according to one or more embodiments described herein;

FIG. 7 schematically depicts alternative steps of the method for analyzing a defect of a hollow core optical fiber, according to one or more embodiments described herein;

FIG. 8 schematically depicts alternative steps of the method for analyzing a defect of a hollow core optical fiber, according to one or more embodiments described herein; and

FIG. 9 is a plot of scattering intensity (y-axis) versus scatter angle (x-axis; in degrees) at various wavelengths, according to one or more embodiments described herein.

### DETAILED DESCRIPTION

Reference will now be made in detail to embodiments of methods for analyzing a hollow core optical fiber described herein, examples of which are illustrated in the accompanying drawings. Whenever possible, the same reference numerals will be used throughout the drawings to refer to the same or like parts.

According to one embodiment, a method of analyzing a hollow core optical fiber includes: disposing a photodetector at an angle greater than 0° and less than 180° relative to a longitudinal axis of a hollow core optical fiber; injecting light into the hollow core optical fiber; measuring, via the photodetector, optical power of the light transmitted through a side of the hollow core optical fiber; and detecting a defect in the hollow core optical fiber based on the measured optical power.

Various embodiments of methods for analyzing a hollow core optical fiber will be described herein with specific reference to the appended drawings.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

Hollow core optical fibers transmit light through a hollow core. Performance of the hollow core optical fiber is generally characterized by the optical power transmitted through the fiber. Different factors, such as deformations that occur during manufacturing, may affect the overall performance of the hollow core optical fiber.

Specifically, hollow core optical fibers may be produced by drawing a preform into fiber. Some hollow core optical fibers include capillaries as cladding elements or cladding elements that include capillaries. The capillaries act to confine light to the hollow core of the fiber. The capillaries are formed from tubes in the preform used to form the hollow core optical fiber. In some preforms, the tubes are directly connected to an annular support structure and centered about a hollow cavity of the preform. During draw of the preform, the tubes may collapse or otherwise deform. This may affect arrangement or dimensions of capillaries formed from the tubes and reduce the effectiveness of capillaries as cladding elements to confine light to the hollow core of the fiber drawn from the preform.

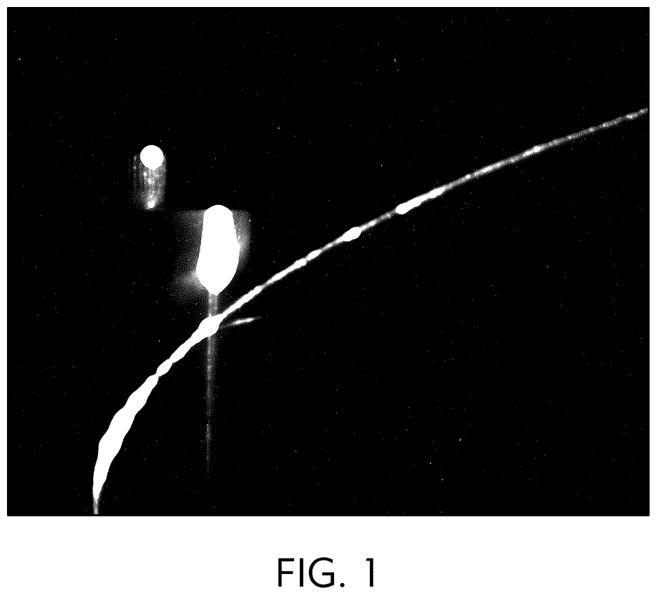

For example, referring to FIG. 1, light at 1550 nm scattering from a side of a lossy hollow core optical fiber near where the light was launched or injected. The fiber in the image is the bright arc from the top-right towards the bottom-left. Variation of light intensity down the length of the fiber is visible.

The presence of a defect in a hollow core optical fiber may be determined via scattering analysis. Due to transmission of the optical signal through an air core, conventional methods of evaluating scattering, such as with an optical time domain reflectometer (OTDR), may present difficulties when used for a hollow core optical fiber as compared to a solid core optical fiber. Additionally, while conventional methods may assist with detecting the presence of a defect, such methods may not provide information on the identity of the defect.

Disclosed herein are methods for analyzing defects in hollow core optical fibers that mitigate the aforementioned problems. Specifically, the methods of analyzing a hollow core optical fiber described herein include measuring, via a photodetector, optical power of light transmitted through a side of a hollow core optical fiber (i.e., side scattering) and, in some embodiments, also evaluating longitudinal angular distribution of the measured optical power. Based on at least one of the measured optical power or the longitudinal angular distribution of the measured optical power, the hollow core optical fiber defect may be detected and/or identified.

Methods for producing hollow core optical fiber include drawing a hollow core optical fiber from a hollow core preform as described in U.S. Patent Application Publication No. 2024/0036249 entitled “METHODS FOR PRODUCING HOLLOW CORE OPTICAL FIBERS,” the entirety of which is incorporated herein by reference.

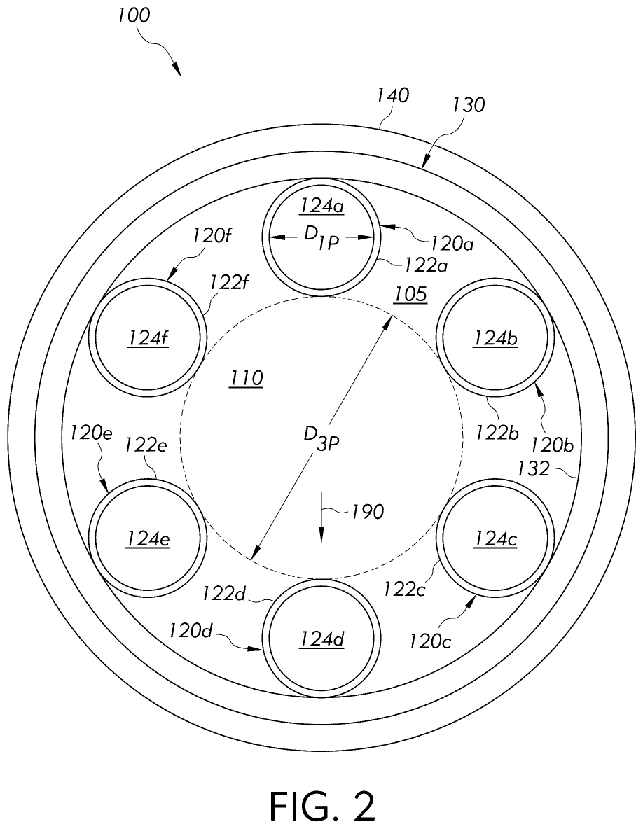

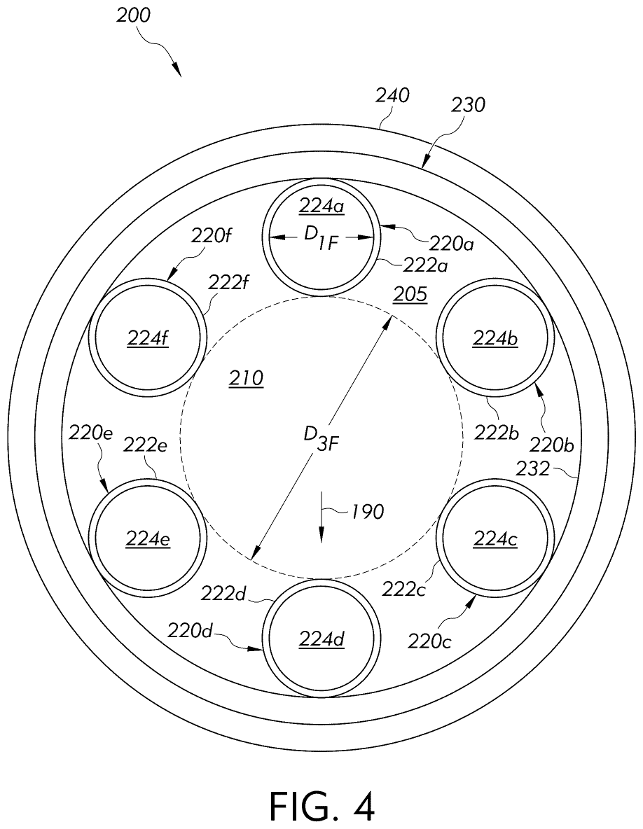

Referring now to FIG. 2, in embodiments, the hollow core preform 100 may comprise an annular support structure 130 with an inner surface 132 defining an interior cavity 105. The interior cavity 105 includes hollow section 110 and tubes 120. Hollow section 110 is the central portion of interior cavity 105 and corresponds to the hollow core region of a hollow core optical fiber 200 (FIG. 4) drawn from hollow core preform 100. Tubes 120 are in contact with the inner surface 132. In the embodiment depicted in FIG. 2, tube 120a is in direct contact with the inner surface 132. It should be noted that the embodiment of the hollow core preform 100 depicted in FIG. 2 includes six tubes, 120a, 120b, 120c, 120d, 120e, and 120f, which may be referred to generally as tube 120 or collectively as tubes 120. It should also be noted that similar notation is used for other repeated structures appearing in the figures of the present disclosure.

In embodiments, the hollow core preform 100 may comprise two or more tubes 120. For example, without limitation, the hollow core preform 100 may comprise two or more, three or more, four or more, five or more, or even six or more tubes 120. In embodiments, each tube 120 may be directly connected to inner surface 132 of the annular support structure 130. For example, without limitation, each tube 120 may be fused to inner surface 132 during production of the hollow core preform 100. Techniques for fusing include laser welding and flame welding.

In embodiments, each tube comprises a wall 122 (i.e., wall 122a, 122b, 122c, 122d, 122e, and 122f) defining an internal opening 124 (i.e., internal openings 124a, 124b, 124c, 124d, 124e, and 124f). In embodiments, at least one internal opening 124 of a tube 120 may have a sealed end. In embodiments, at least two tubes 120 may have an internal opening 124 having a sealed end. For example, without limitation, at least two, at least three, at least four, at least five or even at least six of the tubes 120 may have an internal opening 124 having a sealed end. In embodiments where multiple tubes 120 have an internal opening 124 having a sealed end, the sealed end of each tube 120 may be on the same end of the hollow core preform 100. Tubes having a sealed end are referred to herein as “sealed tubes”. Tubes lacking a sealed end are referred to herein as “open tubes”. Open tubes have open ends. In embodiments, hollow core preform 100 includes only sealed tubes, only open tubes, or a combination of sealed tubes and open tubes. Unless otherwise specified, reference numeral 120 refers to either a sealed tube or an open tube. When a distinction between sealed tubes and open tubes is needed in the description, the terms “sealed” and “open” will be added as qualifiers when referring to tubes 120 (e.g. “sealed tubes 120” or “open tubes 120”). In some embodiments, interior cavity 105 has a sealed end. An interior cavity 105 with a sealed end is referred to herein as a “sealed internal cavity”. An internal cavity 105 lacking a sealed end is referred to herein as an “open internal cavity”. In embodiments, hollow core preform 100 includes an open interior cavity 105 and one or more sealed tubes 120. In embodiments, hollow core preform 100 includes a sealed interior cavity 105 and one or more sealed tubes 120. In embodiments, hollow core preform 100 includes a sealed interior cavity 105 and one or more open tubes 120. In embodiments with a sealed tube or a sealed interior cavity, the tube or interior cavity preferably has one sealed end and one open end. The one sealed end is preferably the end opposite the draw end of hollow core preform 100.

In embodiments, methods for producing hollow core optical fibers may include a preliminary step to form the sealed end of one or more of the tubes 120. In embodiments, at least a portion of the wall 122 defining the internal opening 124 of an open tube 120 may be heated such that at least a portion of the wall 122 defining the internal opening 124 flows together and fuses to itself to form the sealed end and form a sealed tube. For example, without limitation, a sealed end of a tube 120 may be formed by laser welding, plasma welding, or flame welding the material of the tube such that the material fuses to itself. The heating may comprise heating an end of the tube 120 to a temperature suitable for softening the material of the tube 120 such that the material flows together and fuses, thereby sealing the end of the tube 120. The same methods may be used to form a sealed end of interior cavity 105.

In embodiments, forming the sealed tubes does not comprise applying a bonding or filling compound to an end of an open tube. It is contemplated that the sealed end may be formed by heating a portion of the wall of an open tube such that the wall material flows together and fuses to itself to form a seal, without the use of any additional bonding or filling material. In such embodiments, a sealed tube may be substantially free from a bonding compound, a filling compound, or combinations thereof. Without intending to be bound by theory, bonding or filling compounds may fail during the drawing process due to the high temperature of the drawing process and the increase of pressure within the sealed tubes during the drawing process. Failure of a bonding or filling compound may lead to a decrease in pressure within the tube during the drawing process, which may result in partial or total collapse of the capillary in the optical fiber formed in the drawing process. This may result in defects in the hollow core optical fiber drawn from the preform. Forming the sealed end from the wall material of the tube may reduce or substantially prevent failure of the sealed end due to high temperatures of the drawing process and the pressure within the sealed tube during the drawing process. This may allow for improved consistency in the quality of the optical fiber formed during the drawing process.

In embodiments, the hollow core preform 100 further comprises an overclad 140. The overclad is in contact with an outer surface of the annular support structure 130. In an embodiment, the overclad is in direct contact with an outer surface of the annular support structure 130. In such embodiments, the annular support structure 130 may be positioned between the overclad 140 and the interior cavity 105.

In embodiments, the tubes 120 of the hollow core preform 100 may further comprise nested tubes (not depicted), as described in U.S. Patent Application Publication No. 2024/0036249. A nested tube refers to a tube positioned within another tube such that an exterior surface of the nested tube is connected to an interior surface of the other tube. In embodiments, the nested tube may directly contact an interior surface 126 of the wall 122 of the tube 120.

In embodiments, various components of the hollow core preform 100 may comprise silica-based glass. Silica-based glass may include pure silica or silica that is doped with one or more dopants to modify the index of refraction or the viscosity of the silica. In embodiments, the annular support structure 130 may comprise silica-based glass. In embodiments, the wall 122 of one or more of the tubes 120 comprises silica-based glass. In embodiments, the wall 122 of each tube 120 consists or consists essentially of silica-based glass. In embodiments, one or more of the nested tubes (when included) may comprise silica-based glass. In embodiments, the overclad 140 may comprise silica-based glass. Furthermore, in embodiments, any combination of the annular support structure 130, tubes 120, nested capillaries (when included), and overclad 140 may comprise silica-based glass.

In embodiments, the hollow section 110, internal openings 124, and/or the space between tubes 120 comprise a gas. For example, without limitation, the hollow section 110, internal openings 124, and/or space between tubes 120 may comprise air. In embodiments, the hollow section 110, internal openings 124, and/or space between tubes 120 consists essentially of air or even consists of air. In some embodiments, the hollow section 110, internal openings 124, and/or space between tubes 120 consists essentially of an inert gas. As described herein, an inert gas refers to any gas that is non-reactive during the drawing process. Inert gasses may include, but are not limited to, nitrogen, argon, and helium. For example, without limitation, the hollow section 110, internal openings 124, and/or the space between tubes 120 may consist essentially of one or more of nitrogen, argon, or helium.

Methods for producing a hollow core optical fiber may include drawing the hollow core preform 100 into optical fiber. The hollow core perform 100 may be drawn in any suitable draw production system currently known in the art.

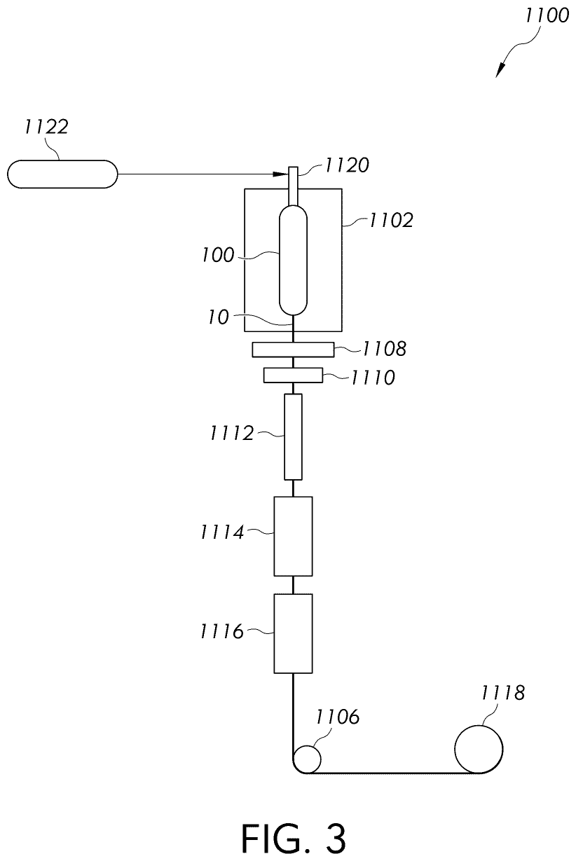

For example, without limitation, the hollow core preform 100 may be drawn into optical fiber in a draw production system 1100, schematically depicted in FIG. 3. The draw production system 1100 includes a draw furnace 1102 that is heated to an elevated temperature (e.g., greater than 1000° C.). The hollow core preform 100 is disposed vertically in the draw furnace 1102 and the draw furnace 1102 supplies heat to the hollow core preform 100. In embodiments, the draw furnace may have a hot zone from about 0.5 inches to about 1 inch positioned toward the bottom of preform 100 heated to a temperature sufficient to soften the draw (lower) end of preform 100 (e.g. a temperature of 1700° C. or higher); however, it should be understood that draw furnaces having larger or smaller hot zones may be used in the methods for producing hollow core optical fiber described herein.

The draw production system 1100 comprises a manifold 1120 attached to the hollow core preform 100. The manifold 1120 may be attached to the end of the hollow core preform that is opposite the draw end of the hollow core preform 100. The manifold 1120 may be fluidly connected to a gas supply 1122, and the manifold 1120 may be operable to supply gas to the hollow core of hollow core preform 100. The flow of gas from gas supply 1122 to the hollow core preform 100 via manifold 1120 may be controlled to regulate the pressure of the hollow core of the hollow core preform 100 during the drawing process. The flow of gas from the gas supply 1122 to the hollow core preform may be controlled by any suitable means. For example, without limitation, the flow rate of gas from the gas supply to the hollow core preform 110 may be controlled manually or by an automated control system.

During the drawing of optical fiber, the optical fiber 10 is pulled from a bottom portion (softened draw end) of hollow core preform 100 by tractor 1106. After leaving the draw furnace 1102, the optical fiber 10 encounters a diameter monitoring device 1108 that provides a signal used in a feedback control loop to regulate a speed of tractor 1106 and maintain a constant fiber diameter. The optical fiber 10 then passes through a fiber tension measurement device 1110 that measures the tension of the optical fiber 10 and provides a feedback control loop to regulate the tension of optical fiber 10 and maintain a desired draw tension setting.

Still referring to FIG. 3, once the optical fiber 10 is drawn from hollow core preform 100, the optical fiber 10 is cooled in a cooling tube 1112 or other controlled cooling treatment device that may be coupled to or remote from the exit of the draw furnace 1102, afterwards optical fiber 10 is coated by coater 1114 that can apply a polymerizable coating material to the outside surface of the optical fiber 10. The optical fiber 10 may also pass through a coating curing apparatus 1116 that cures the polymer coating (e.g. with ultraviolet light). The optical fiber 10 is then wound onto a spool or reel 1118. Various optical attributes of the optical fiber, such as attenuation, are typically measured off-line.

Referring now to FIG. 4, a hollow core optical fiber 200 is shown. Hollow core optical fiber 200 can be formed, for example, by drawing the hollow core preform 100 shown in FIG. 2. The hollow core optical fiber 200 may comprise a substrate 230 with an inner surface 232 defining an interior space 205. The interior space 205 includes hollow core 210 and capillaries 220. Hollow core 210 is the central portion of interior space 205 and corresponds to the region of hollow core optical fiber 200 in which optical signals are confined. Capillaries 220 are cladding elements of hollow core optical fiber 200. Capillaries 220 are in contact with inner surface 232. In the embodiment depicted in FIG. 4, capillaries 220 are in direct contact with the inner surface 232. It should be noted that the embodiment of the hollow core optical fiber 200 depicted in FIG. 4 includes six capillaries, 220a, 220b, 220c, 220d, 220e, and 220f, which may be referred to generally as capillary 220 or collectively as capillaries 220. Capillaries 220 are formed from corresponding tubes 120 of the hollow core preform 100 during the draw process (e.g. capillary 220a is formed from tube 120a, etc.). Hollow core 210 is formed from hollow section 110 of the hollow core preform 100. As hollow core preform 100 is drawn, tubes 120 thin and contract in diameter to form capillaries 220 of hollow core optical fiber 200. Corresponding thinning and contraction of annular support structure 130 to form substrate 230 occurs. Corresponding contraction of hollow section 110 to form hollow core 210 also occurs. Hollow core optical fiber 200 can be viewed as a scaled down version of hollow core preform 100. As further discussed hereinbelow, variation of the pressure in internal cavity 105 of hollow core preform 100 during draw and/or sealing of tubes 120 of hollow core preform 100 enable control over the diameter and wall thickness of capillaries 220 and substrate 230 as well as the diameter of hollow core 210.

In embodiments, the hollow core optical fiber 200 may comprise two or more capillaries 220. For example, without limitation, the hollow core optical fiber 200 may comprise two or more, three or more, four or more, five or more, or even six or more capillaries 220. In embodiments, each capillary 220 may be in direct contact with inner surface 232 of the substrate 230.

In embodiments, each capillary 220 comprises a wall 222 (i.e., wall 222a, 222b, 222c, 222d, 222e, and 222f) defining an internal opening 224 (i.e., internal openings 224a, 224b, 224c, 224d, 224e, and 224f). In embodiments, each capillary 220 may further comprise a nested capillary (not depicted).

In embodiments, the hollow core optical fiber 200 further comprises an overclad 240 derived from overclad 140 of hollow core preform 100. The overclad 240 is in contact with an outer surface of the substrate 230. In an embodiment, the overclad 240 is in direct contact with an outer surface of the substrate 230. In such embodiments, the substrate 230 is positioned between the overclad 240 and the hollow core 210.

Referring again to FIG. 2, in embodiments, drawing the hollow core preform 100 varies an inner diameter D₁ₚ of the internal opening 124 of one or more of the tubes 120 to form capillaries 220 with inner diameter D_{1f}. In particular, without limitation, drawing the hollow core preform 100 may decrease an inner diameter D₁ₚ of the internal opening 124 of one or more of the tubes 120 to an inner diameter D_{1f} when forming capillaries 220. The capillary inner diameter D_{1f} is particularly easy to control when forming capillaries 220 from sealed tubes 120. In embodiments, drawing the hollow core preform 100 may decrease the inner diameter D₁ₚ of the internal opening 124 of each tube 120 to form a plurality of capillaries 220 with the inner diameter D_{1f}. The inner diameter D_{1f} is, for example, without limitation, from 12 μm to 50 μm, from 16 μm to 50 μm, from 20 μm to 50 μm, from 24 μm to 50 μm, from 28 μm to 50 μm, from 32 μm to 50 μm, from 36 μm to 50 μm, from 40 μm to 50 μm, from 44 μm to 50 μm, from 48 μm to 50 μm, from 12 μm to 46 μm, 12 μm to 42 μm, from 12 μm to 38 μm, from 12 μm to 34 μm, from 12 μm to 30 μm, from 12 μm to 26 μm, from 12 μm to 22 μm, from 12 μm to 18 μm, from 12 μm to 16 μm, or any combination or sub-set of these ranges. In embodiments, each capillary may have the same inner diameter D_{1f}.

In embodiments, drawing the hollow core preform 100 varies a diameter D₃ₚ of the hollow section 110. As described herein, a diameter D₃ₚ of the hollow section 110 is the diameter of a circle that is concentric with the annular support structure 130 and tangent to the tubes 120, depicted as the dashed circle in FIG. 2. The region associated with diameter D₃ₚ is the hollow section 110, which defines the hollow core 210 of the hollow core optical fiber 200 drawn from hollow core preform 100. The dashed circle defines the boundaries of the hollow section 110 of interior cavity 105. The diameter D₃ₚ is twice the radius of the hollow section 110, where the radius of the hollow section 110 is the shortest distance from the center of the hollow section 110 to the outer surface 122 of tubes 120. In embodiments in which the inner diameter D₁ₚ and wall thickness is the same for each of the tubes 120, the radius of the hollow section 110 is the same for all tubes 120. In some embodiments, small differences in D₁ₚ and/or wall thickness of the tubes 120 may arise during manufacturing. In such embodiments, the radius of the hollow section 110 is taken to be the smallest of the radii to the different tubes 120; that is, the shortest of the distances from the center of hollow section 110 to a point of tangency with a tube 120. In embodiments, drawing the hollow core preform 100 may decrease a diameter D₃ₚ of the hollow section 110 to form hollow core 210 having a diameter D_{3f} in hollow core optical fiber 200.

The hollow core preform 100 may be drawn at a temperature of from 1700° C. to 2150° C. For example, without limitation, drawing the hollow core preform 100 may occur at a temperature from 1700° C. to 2150° C., from 1700° C. to 2100° C., from 1700° C. to 2050° C., from 1700° C. to 2000° C., from 1700° C. to 1950° C., from 1700° C. to 1900° C., from 1700° C. to 1850° C., from 1700° C. to 1800° C., from 1700° C. to 1750° C., from 1750° C. to 2150° C., from 1800° C. to 2150° C., from 1850° C. to 2150° C., from 1900° C. to 2150° C., from 1950° C. to 2150° C., from 2000° C. to 2150° C., from 2050° C. to 2150° C., from 2100° C. to 2150° C., or any combination or sub-set of these ranges.

In embodiments, hollow core optical fiber 200 may be drawn from the hollow core preform 100 at a rate from 0.1 m/s to 60 m/s. For example, without limitation, hollow core optical fiber 200 may be drawn from the hollow core preform 100 at a rate from 0.1 m/s to 60 m/s, from 0.5 m/s to 60 m/s, from 1 m/s to 60 m/s, from 5 m/s to 60 m/s, from 10 m/s to 60 m/s, from 20 m/s to 60 m/s, from 30 m/s to 60 m/s, from 40 m/s to 60 m/s, from 50 m/s to 60 m/s, from 0.1 m/s to 50 m/s, from 0.1 m/s to 40 m/s, from 0.1 m/s to 30 m/s, from 0.1 m/s to 20 m/s, from 0.1 m/s to 10 m/s, from 0.1 m/s to 5 m/s, from 0.1 m/s to 1 m/s, from 0.1 m/s to 0.5 m/s, or any combination or sub-set of these ranges.

In embodiments, the hollow core preform 100 may be drawn at a tension from 30 g to 400 g to form hollow core optical fiber 200. For example, without limitation, the hollow core preform 100 may be drawn at a tension from 30 g to 400 g, from 50 g to 400 g, from 100 g to 400 g, from 150 g to 400 g, from 200 g to 400 g, from 250 g to 400 g, from 300 g to 400 g, from 350 g to 400 g, from 30 g to 350 g, from 30 g to 300 g, from 30 g to 250 g, from 30 g to 200 g, from 30 g to 150 g, from 30 g to 100 g, from 30 g to 50 g, or any combination or sub-set of these ranges.

Drawing the hollow core preform 100 may include regulating a pressure of the interior cavity 105 as described in U.S. Patent Publication No. 2024/0036249. In embodiments, the pressure may be varied over time during the draw. Without intending to be bound by theory, the applied pressure may be a pressure that prevents the collapse or deformation of tubes 120 during the drawing process. During the drawing process, the pressure in the tubes 120 may be greater than the pressure in the interior cavity 105, to prevent collapse of the capillaries. Adjusting the difference in pressure between the tubes 120 and the interior cavity 105 may allow the inner diameter D₁ₚ of the internal opening 124 of the tubes 120 and the diameter D₃ₚ of the hollow section 110 of the hollow core preform 110 to be controlled during draw to form corresponding features (hollow core 210 and capillaries 220) of hollow core optical fiber 200. When the tubes 120 are sealed, adjusting the difference in pressure between the pressure in the capillaries and the pressure in the interior cavity 105 may be achieved by adjusting the pressure of the interior cavity 105.

In embodiments, regulating the pressure of the internal cavity 105 comprises passing one or more gasses into the internal cavity 105. In embodiments, the one or more gasses may comprise one or more inert gasses. For example, the one or more inert gasses may comprise nitrogen, argon, and helium. In embodiments, the one or more gasses may comprise air.

The one or more gasses may be passed to the internal cavity 105 through a manifold (for example, manifold 1120 in FIG. 3). In embodiments, methods for producing hollow core optical fibers 200 may comprise attaching a manifold 1120 to the hollow core preform 100 before drawing the hollow core preform 100 to form hollow core optical fiber 200. The manifold 1120 may be any apparatus suitable to pass one or more gasses to the internal cavity 105 during the drawing process. The manifold 1120 may be attached to the hollow core preform 100 by any suitable means. For example, without limitation, the manifold 1120 may be formed of glass and may be welded to the hollow core preform 100. It should be understood that the manifold 1120 may be attached to the hollow core preform 100 proximate to the sealed ends of the tubes 120. As such, the manifold 1120 may be used to supply a gas to the internal cavity 110 of the hollow core preform 100 without also introducing gas into the sealed ends of the tubes 120 (and nested tubes, when included). Accordingly, the inclusion of tubes 120 with sealed ends (and nested tubes with sealed ends, when included) may simplify the connection of the manifold 1120 to the hollow core preform 100 by eliminating the need for individual manifold 1120 connections to the tubes 120 (and nested tubes, when included) to separately and independently regulate the pressure within each tube.

Drawing the hollow core preform 100 may produce a hollow core optical fiber 200. As noted above, drawing the hollow core preforms 100 depicted in FIG. 2 produces the hollow core optical fiber 200 depicted in FIG. 4. The number, arrangement, and dimensions of tubes 120 in hollow core preform 100 can be varied to produce hollow core optical fibers 200 of various designs. Further, by regulating the pressure of internal cavity 105 during the draw, the inner diameter D_{1f} of openings 224 of capillaries 220, the inner diameter of openings of nested capillaries (when included), the wall thickness of capillaries 220 and nested capillaries (when included), and the diameter D_{3f} of hollow core 210 of hollow core optical fiber 200 can be controlled when drawing hollow core optical fiber 200 from a given hollow core preform 100. That is, by regulating the pressure in the internal cavity 105 during draw, a variety of hollow core optical fibers 200 with differing internal dimension can be produced from the same hollow core preform 100. For example, the pressure in the internal cavity 105 can be regulated to a first pre-determined pressure over a first time interval during draw of a particular hollow core preform 100 to produce a hollow core optical fiber 200 have a first set of internal dimensions and regulated to a second pre-determined pressure over a second time interval to produce a hollow core optical fiber 200 having a second set of internal dimensions.

In embodiments, the capillaries 220 of hollow core optical fiber 200 are configured to provide an anti-resonant effect to increase confinement of an optical signal in hollow core 210.

As used herein, an “anti-resonant effect” refers to an effect that occurs when the thickness of a material (e.g. the wall thickness of capillaries 220) is proportional to a wavelength of light passing through the hollow core optical fiber such that the light passing through the hollow core optical fiber is confined to the hollow core. Without intending to be bound by theory, an anti-resonant effect occurs when the thickness of a material satisfies the quarter-wave condition (phase accumulated on a single pass is one quarter of 2π, and any odd multiple of a quarter wave). When this condition is applied to the thickness of the material, light is confined to the hollow core with minimum leakage to the cladding. In other words, this condition helps inhibit coupling between core modes and cladding modes, resulting in low loss of transmission and increased confinement of the optical signal in the hollow core. The anti-resonant effect, in one embodiment, may be satisfied by a material having a thickness given by Equation 1:

$${t}_{A R} = \frac{( 2 m - 1 ) λ}{( 4 {\{ {n}^{2} - 1 \}}^{1 / 2} )} \qquad Equation 1$$

In Equation 1, t_{AR} is the thickness of the material that satisfies the anti-resonance condition, A is the wavelength of the optical signal, m is an integer that is greater than or equal to 1, and n is the refractive index of the material. It should be noted that Equation 1 represents an ideal thickness of a material that would satisfy the anti-resonant effect, and that material thicknesses that are not exactly equal to t_{AR} may also provide increased confinement of light to the hollow core. For example, without limitation, it is contemplated that a material having a thickness within 10% of t_{AR} (from 90% t_{AR} to 110% t_{AR}) may be operable to confine light to the hollow core.

In embodiments, the anti-resonant elements (i.e., the capillaries 220 and nested capillaries (when included)) may be operable to confine an optical signal to the hollow core by an inhibited coupling mechanism. As used herein, an “inhibited coupling mechanism” refers to an effect that occurs when cladding elements having negative curvature inhibit coupling between core modes and cladding modes to reduce light leakage from the hollow core. As used herein, “negative curvature” refers to cladding elements having a surface with a convex shape facing the central longitudinal axis of the hollow core optical fiber. Without intending to be bound by theory, using cladding elements having a surface with a convex shape facing the central longitudinal axis of the hollow core optical fiber may reduce the amount of light that contacts the cladding elements and may also reduce the light leaking through the cladding elements and the gaps between these cladding elements. In turn, this may reduce attenuation of the optical signal due to the leaking through the cladding elements and the gaps between them and may also reduce light scattering that may occur when light contacts the surface of the cladding elements.

As the confinement of light in the hollow core 210 of the hollow core optical fiber 200 is at least partially dependent on the arrangement and dimensions of the capillaries 220, it is useful to determine the type and location of any defect in the hollow core optical fiber 200. Such defects may result in the anti-resonant effect of the capillaries being compromised and sections of the hollow core optical fiber 200 being unduly “lossy” due to the leakage of light from the hollow core 210, adversely impacting the propagation of optical signals over the length of the optical fiber. Determining the type and location of the defect allows for analysis and troubleshooting. However, conventional methods may not provide information on the root cause of the defect in a hollow core optical fiber and, thus, do not allow for in-depth trouble shooting and analysis.

The techniques described herein may facilitate analysis of the hollow core optical fiber, allowing for defect detection, defect identification, and trouble shooting. In particular, the present application measures optical power of light transmitted through a side of a hollow core optical fiber (i.e., side scattering) and, in embodiments, evaluates the longitudinal angular distribution of the measured optical power. Based on at least one of the measured optical power or the longitudinal angular distribution of the measured optical power, the hollow core optical fiber defect may be detected and/or identified.

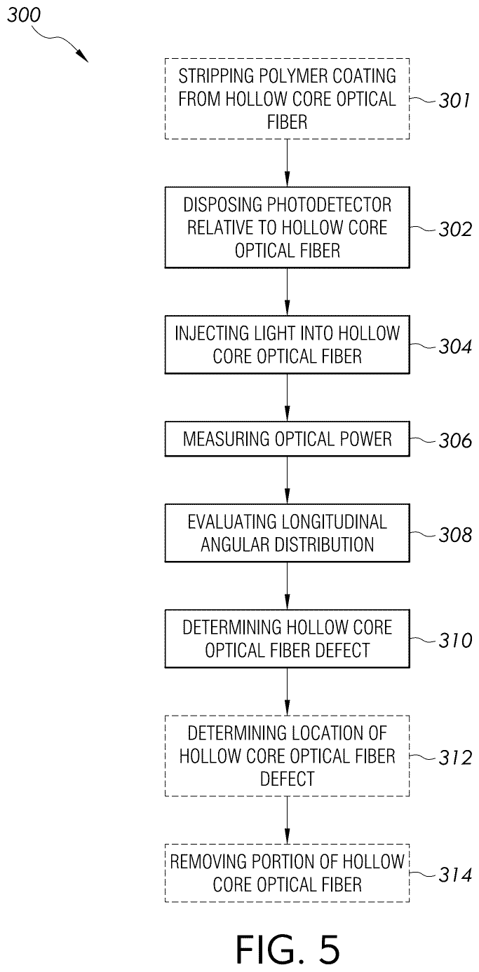

Referring now to FIG. 5, a method for analyzing a hollow core optical fiber is shown at 300. The method 300 may optionally begin at block 301 with stripping a polymer coating from the hollow core optical fiber.

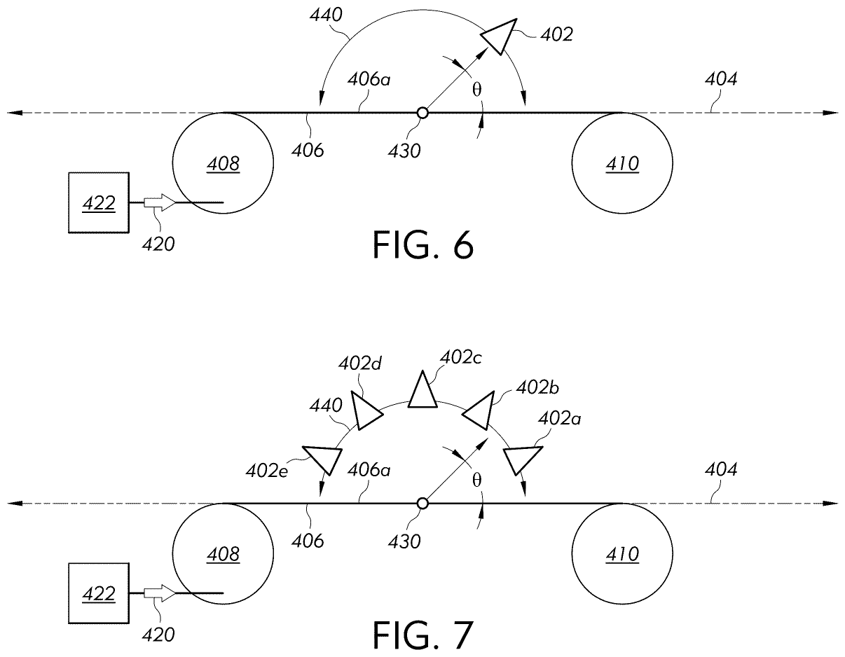

Referring back to FIG. 5 and with reference to FIG. 6, the method 300 may continue at block 302 with disposing a photodetector 402 relative to a longitudinal axis 404 of a hollow core optical fiber 406. The photodetector 402 may be a photodetector known in the art having high sensitivity. For example, the photodetector may be a detector with a single sensor area, such as a photodiode. The photodetector may have more than one or multiple, sensor areas, such as a quadrant detector. The photodetector may have many sensor areas, such as a linescan camera, a 2D camera, CMOS detector, or CCD detector. The photodetector may also have wavelength dependent components such as filters, films, or gratings. The photodetector 402 measures optical power of light received from hollow core optical fiber 406.

The photodetector 402 may be disposed at an angle θ relative to the longitudinal axis 404 of the hollow core optical fiber 406. Disposing the photodetector 402 at a known angle θ allows for evaluation of the longitudinal angular distribution of the optical power measured by the photodetector 402. In embodiments, the angle θ relative to the longitudinal axis 404 of the hollow core optical fiber 406 may be greater than 0° and less than 180°. In embodiments, the angle θ relative to the longitudinal axis 404 of the hollow core optical fiber 406 may be greater than 0°, greater than or equal to 30°, greater than or equal to 60°, greater than or equal to 90°, greater than or equal to 120°, or even greater than or equal to 150°. In embodiments, the angle θ relative to the longitudinal axis 404 of the hollow core optical fiber 406 may be less than 180°, less than or equal to 150°, less than or equal to 120°, less than or equal to 90°, less than or equal to 60°, or even less than or equal to 30°. In embodiments, the angle θ relative to the longitudinal axis 404 of the hollow core optical fiber 406 may be greater than 0° and less than 180°, greater than 0° and less than or equal to 150°, greater than 0° and less than or equal to 120°, greater than 0° and less than or equal to 90°, greater than 0° and less than or equal to 60°, greater than 0° and less than or equal to 30°, greater than or equal to 30° and less than 180°, greater than or equal to 30° and less than or equal to 150°, greater than or equal to 30° and less than or equal to 120°, greater than or equal to 30° and less than or equal to 90°, greater than or equal to 30° and less than or equal to 60°, greater than or equal to 60° and less than 180°, greater than or equal to 60° and less than or equal to 150°, greater than or equal to 60° and less than or equal to 120°, greater than or equal to 60° and less than or equal to 90°, greater than or equal to 90° and less than 180°, greater than or equal to 90° and less than or equal to 150°, greater than or equal to 90° and less than or equal to 120°, greater than or equal to 120° and less than 180°, greater than or equal to 120° and less than or equal to 150°, or even greater than or equal to 150° and less than 180°, or any and all sub-ranges formed at any of these endpoints.

Referring now to FIG. 7, in embodiments, the photodetector 402 may comprise a plurality of photodetectors 402a, 402b, 402c, 402d, 402e disposed at various points at various angles θ relative to the longitudinal axis 404 of a hollow core optical fiber 406. For example, one of the plurality of photodetectors 402a, 402b, 402c, 402d, 402e may be disposed at greater than 0°, at 30°, at 60°, at 90°, at 120°, at 150°, or at less than 180°, or any and all ranges formed from any of these points relative to the longitudinal axis 404 of the hollow core optical fiber 406. In embodiments, the photodetector 402 may comprise at least 2, at least 3, at least 4, or even at least 5 photodetectors.

Referring to FIGS. 6 and 7, the hollow core optical fiber 406 may be disposed on a payoff spool 408 and a takeup spool 410. The hollow core optical fiber 406 may extend between the payoff spool 408 and the takeup spool 410 along the longitudinal axis 404 of the hollow core optical fiber 406.

Referring again to FIGS. 5-7, the method 300 may continue at block 304 with injecting light 420 into the hollow core optical fiber 406. The light 420 may be provided by a light source 422. In embodiments, with reference to FIG. 4, the light 420 may be injected into a core 210 of the hollow core optical fiber 200, 406; a substrate 230 of the hollow core optical fiber 200, 406; a capillary 222 of the hollow core optical fiber 200, 406; or combinations thereof.

In embodiments, the light source 422 may be a substantially single wavelength source (e.g., a laser), or a broadband source (e.g., a light emitting diode or a superluminescent light emitting diode), or a combination of sources to space several distinct wavelengths or to span a full range broader than a single source.

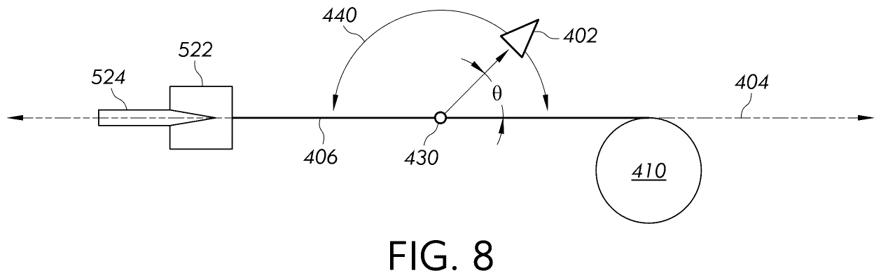

Referring now to FIG. 8, the light source may be a thermal radiant source (e.g., the hot zone) of a draw furnace 522, which produces light as a wide spectrum radiation source. The light from the thermal radiant source may be coupled with the core 210 of the hollow core optical fiber 200, 406 (FIG. 4) as well as hot glass regions of the hollow core optical fiber 200, 406. In this embodiment, a blank 524 blank will advance through the draw furnace 522 and the hollow core optical fiber 406 will advance out of the draw furnace 522 through the inspection point 430 as the hollow core optical fiber 406 is drawn.

In embodiments, the light 420 injected into the hollow core optical fiber 406 may comprise a single wavelength or multiple wavelengths. In embodiments, the light 420 injected into the hollow core optical fiber 406 may comprise a wavelength greater than or equal to 1000 nm and less than or equal to 1700 nm. In embodiments, the light 420 injected into the hollow core optical fiber 406 may comprise a wavelength greater than or equal to 1000 nm, greater than or equal to 1200 nm, greater than or equal to 1300 nm, greater than or equal to 1400 nm, or even greater than or equal to 1500 nm. In embodiments, the light 420 injected into the hollow core optical fiber 406 may comprise a wavelength less than or equal to 1700 nm, less than or equal to 1600 nm, less than or equal to 1500 nm, less than or equal to 1400 nm, less than or equal to 1300 nm, or even less than or equal to 1200 nm. In embodiments, the light 420 injected into the hollow core optical fiber 406 may comprise a wavelength greater than or equal to 1000 nm and less than or equal to 1700 nm, greater than or equal to 1000 nm and less than or equal to 1600 nm, greater than or equal to 1000 nm and less than or equal to 1500 nm, greater than or equal to 1000 nm and less than or equal to 1400 nm, greater than or equal to 1000 nm and less than or equal to 1300 nm, greater than or equal to 1000 nm and less than or equal to 1200 nm, greater than or equal to 1100 nm and less than or equal to 1700 nm, greater than or equal to 1100 nm and less than or equal to 1600 nm, greater than or equal to 1100 nm and less than or equal to 1500 nm, greater than or equal to 1100 nm and less than or equal to 1400 nm, greater than or equal to 1100 nm and less than or equal to 1300 nm, greater than or equal to 1100 nm and less than or equal to 1200 nm, greater than or equal to 1300 nm and less than or equal to 1700 nm, greater than or equal to 1300 nm and less than or equal to 1600 nm, greater than or equal to 1300 nm and less than or equal to 1500 nm, greater than or equal to 1300 nm and less than or equal to 1400 nm, greater than or equal to 1400 nm and less than or equal to 1700 nm, greater than or equal to 1400 nm and less than or equal to 1600 nm, greater than or equal to 1400 nm and less than or equal to 1500 nm, greater than or equal to 1500 nm and less than or equal to 1700 nm, or even greater than or equal to 1500 nm and less than or equal to 1600 nm, or any and all sub-ranges formed from any of these endpoints.

Referring again to FIGS. 5-7, the method 300 may continue at block 306 with measuring, via the photodetector 402, optical power of the light 420 transmitted through a side 406a of the hollow core optical fiber 406. Due to transmission through the core 210 (FIG. 4), any light scattering from the hollow core optical fiber 406 may scatter through or from the side 406a of the hollow core optical fiber 406. The photodetector 402 may measure optical power at an inspection point 430 or any other point of the hollow core optical fiber 406 extending between the payoff spool 408 and the takeup spool 410 along the longitudinal axis 404 of the hollow core optical fiber 406. In embodiments including a plurality of photodetectors 402a, 402b, 402c, 402d, 402e, each photodetector may measure optical power at an inspection point 430 or any other point of the hollow core optical fiber 406 extending between the payoff spool 408 and the takeup spool 410 along the longitudinal axis 404 of the hollow core optical fiber 406. In embodiments including a plurality of photodetectors 402a, 402b, 402c, 402d, 402e, each of the plurality of photodetectors 402a, 402b, 402c, 402d, 402e may measure optical power at a same point of the hollow core optical fiber 406 or may measure optical power at a different point of the hollow core optical fiber 406 relative to another of the plurality of photodetectors 402a, 402b, 402c, 402d, 402e. During the measuring step, each of the plurality of photodetectors 402a, 402b, 402c, 402d, 402e may make simultaneous measurements of the optical power or may make measurements of optical power at different times relative to another of the plurality of photodetectors 402a, 402b, 402c, 402d, 402e. In embodiments, the photodetector 402 or the plurality of photodetectors 402a, 402b, 402c, 402d, 402e may be wavelength selective, or may split the wavelengths into separate photodetectors which can analyze each wavelength separately (e.g., a spectrometers). The photodetector 402 or the plurality of photodetectors 402a, 402b, 402c, 402d, 402e may be physically separated from the inspection point 430 by a fiber coupling, which channels light from the inspection point 430 to the photodetector 402 or the plurality of photodetectors 402a, 402b, 402c, 402d, 402e.

In embodiments, during the measuring step, the hollow core optical fiber 406 may be moved along the longitudinal axis 404 of the hollow core optical fiber 406. For example, during the measuring step, the hollow core optical fiber 406 may be advanced from the payoff spool 408 to the takeup spool 410 along the longitudinal axis 404 of the hollow core optical fiber 406. In such embodiments, during the measuring step, the photodetector 402 or the plurality of photodetectors 402a, 402b, 402c, 402d, 402e may be fixed.

In other embodiments, during the measuring step, the photodetector 402 or the plurality of photodetectors 402, 402b, 402c, 402d, 402e may be moved along an arc 440 at the angle θ relative to a longitudinal axis 404 of the hollow core optical fiber 406. In such embodiments, during the measuring step, the hollow core optical fiber 406 may be fixed. In embodiments including a plurality of photodetectors 402, 402b, 402c, 402d, 402e, each of the plurality of photodetectors 402a, 402b, 402c, 402d, 402e may be moved along the arc 440 or remain fixed.

Referring back to FIG. 5, the method 300 may continue at block 308 with evaluating longitudinal angular distribution of the optical power measurement. As mentioned hereinabove, referring to FIGS. 6 and 7, disposing the photodetector 402 or plurality of photodetectors 402, 402b, 402c, 402d, 402e at a known angle θ allows for evaluation of the longitudinal angular distribution of the optical power measured by the photodetector 402 or plurality of photodetectors 402, 402b, 402c, 402d, 402e.

Referring back to FIG. 5, the method 300 may continue at block 310 with detecting a defect of a hollow core optical fiber based on at least one of the measured optical power or the longitudinal angular distribution of the measured optical power. The measured optical power and/or the longitudinal angular distribution of the measured optical power may be indicative of a type of defect of the hollow core optical fiber, and thus may be used to identify defects of the hollow core optical fiber such as capillary detachment from a substrate wall, capillaries touching an adjacent capillary, capillary deformities (i.e., with respect to a desired shape), capillary gap deformities, or a combination thereof.

For example, in embodiments, detection of a defect of the hollow core fiber comprises comparing the measured optical power to a predetermined threshold. The predetermined threshold, for example, may be derived from a calibration of a particular type of defect of the hollow core optical fiber obtained from control samples configured to have the particular type of defect of the hollow core optical fiber. In other embodiments, calibrations of the longitudinal angular distribution of the optical power of a particular type of defect of the hollow core optical fiber can be determined with control samples configured to have the particular type of defect of the hollow core optical fiber and used to identify the particular type of defect of the hollow core optical fiber. In still other embodiments, calibrations based on the wavelength dependence of the measured optical power of a particular defect at one or more angles θ can be determined with control samples configured to have the particular type of defect of the hollow core optical fiber and used to identify the particular type of defect of the hollow core optical fiber. Control samples can be configured to include a particular type of defect by intentionally creating the defect in an otherwise non-defective specimen of a hollow-core optical fiber. Alternatively, defective specimens of hollow-core optical fiber produced during manufacture can be collected and characterized to identify hollow-core optical fibers having a particular type of defect.

The methods described herein are length-dependent, meaning the analysis of the hollow core optical fiber may occur section-by-section along the length of the hollow core optical fiber. For example, a portion of the hollow core optical fiber 406 may be analyzed and then advanced from the payoff spool 408 to the takeup spool 410 along the longitudinal axis 404 of the hollow core optical fiber 406. As such, referring back to FIG. 5, in embodiments, the method 300 may optionally continue at block 312 with determining a location of the hollow core optical fiber defect.

As mentioned herein, the methods described herein may facilitate analysis of the hollow core optical fiber, allowing defect identification and trouble shooting. Referring back to FIGS. 5-7, the method 300 may optionally continue at block 314 with removing a portion of the hollow core optical fiber 406 that includes the defect of the hollow core optical fiber such that the non-defective portion of the hollow core optical fiber 406 remains functional.

### Examples

In order that various embodiments be more readily understood, reference is made to the following examples, which are intended to illustrate various embodiments of methods for analyzing a hollow core optical fiber.

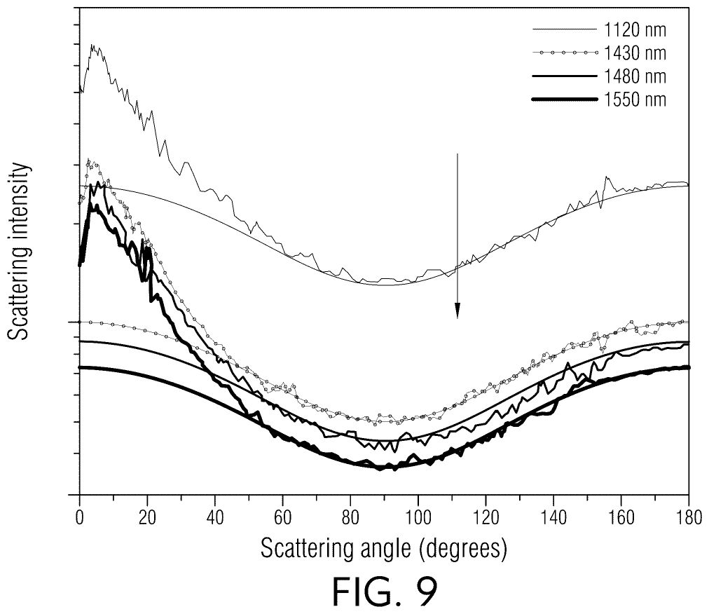

Referring now to FIG. 9, a plot of measured optical power (labelled “scattering intensity”) as a function of the angle θ (labeled “scattering angle”) at four wavelengths is shown. The smooth curves are the corresponding Rayleigh fits through the data. As exemplified by FIG. 9, in view of the angular dependence of scattering, the methods for analyzing a hollow core optical fiber as described herein may be used for defect identification and trouble shooting.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

What is claimed is:

1. A method for analyzing a hollow core optical fiber, the method comprising:
disposing a photodetector at an angle greater than 0° and less than 180° relative to a longitudinal axis of a hollow core optical fiber;
injecting light into the hollow core optical fiber;
measuring, via the photodetector, optical power of the light transmitted through a side of the hollow core optical fiber;
and
detecting a defect in the hollow core optical fiber based on the measured optical power.

2. The method of claim 1, wherein the measuring of the optical power comprises evaluating a longitudinal angular distribution of the optical power of the light transmitted through a side of the hollow core optical fiber.

3. The method of claim 2, wherein the detecting is based on the longitudinal angular distribution.

4. The method of claim 1, wherein the detecting comprises determining a location of the defect.

5. The method of claim 4, wherein the method further comprises removing a portion of the hollow core optical fiber, the portion including the defect.

6. The method of claim 1, wherein the detection comprises identifying the defect.

7. The method of claim 1, wherein the photodetector comprises a plurality of photodetectors disposed at various angles greater than 0° and less than 180° relative to the longitudinal axis of the hollow core optical fiber.

8. The method of claim 1, wherein the light is injected into a core of the hollow core optical fiber, a substrate of the hollow core optical fiber, a capillary of the hollow core optical fiber, or combinations thereof.

9. The method of claim 1, wherein the light injected into the hollow core optical fiber comprises a wavelength greater than or equal to 1000 nm and less than or equal to 1700 nm.

10. The method of claim 1, wherein the light injected into the hollow core optical fiber comprises a plurality of wavelengths.

11. The method of claim 1, wherein during the measuring step, the hollow core optical fiber is moved along the longitudinal axis of the hollow core optical fiber.

12. The method of claim 1, wherein during the measuring step, the photodetector is moved along an arc at angles greater than 0° and less than 180° relative to the longitudinal axis of the hollow core optical fiber.

13. The method of claim 1, wherein the defect of the hollow core optical fiber comprises capillary detachment, capillaries touching, capillary deformities, capillary gap deformities, or a combination thereof.

14. The method of claim 1, wherein the detecting the defect comprises comparing the measured optical power to a predetermined threshold.

15. The method of claim 1, wherein the method further comprises stripping a polymer coating from the hollow core optical fiber prior to the measuring step.
